(19) United States
(12) Patent Application Publication
(10) Pub. No.: US 2008/0288488 A1
(43) Pub. Date: Nov. 20, 2008

(54) Method and system for determining trend potentials

(75) Inventors: Martin Gert Muecke, Hilden (DE); Christian Pohl, Guetersloh (DE)

Correspondence Address: Davidson, Davidson & Kappel, LLC, 485 7th Avenue, 14th Floor, New York, NY, 10018, US

(73) Assignee: IPRM Intellectual Property Rights Management AG c/o Dr. Hans Durrer, Zug (CH)

(21) Appl. No.: 11/827,568

(22) Filed: Jul. 12, 2007

(30) Foreign Application Priority Data
May 15, 2007 (DE) DE102007022739.8

(51) Int. Cl. G06F 7/00

(52) U.S. Cl. 707/6; 707/E17.014

(57) ABSTRACT

A method for determining a significant change of an usage of expressions provided in a network system, including the steps of determining a reference data set including at least an expression frequency of expressions provided in the network system at a predetermined first time; determining a result data set including at least an indication of an expression frequency change based on the reference data set, wherein the expression frequency change indicates the change of the expression frequency of expressions indicated by the reference data set at a predetermined second time; and extracting, from the result data set, one or more expressions according to one or more predetermined filters to determine the change of the usage of expression in the network system.

This claims the benefit of German Patent Application No. DE 10 2007 022 739.8, filed on May 15, 2007 and hereby incorporated by reference herein.

### BACKGROUND

The present invention is related to a method and a system for determining a significant change of a usage of expressions in a network system such as the Internet. In particular, the present invention is related to a method and a system to determine a future trend based on the usage of expressions in the data provided in the network system.

There are different reasons why the change of a usage of expressions, such as words, combination of words, slogans, phrases, pictures, illustrations, sounds, videos, codes and the like over time might be interesting. Possible fields in which such information could be useful are the spreading of codes of programs, such as viruses, in a network system or the spreading of language expressions in the network. The latter might be in particular relevant for trend research where existing and future trends are detected and analyzed.

A trend is commonly understood as a tendency by which technical, social, political, or economic developments take place. In particular, in the fields of market research and trend research it is sought to forecast medium term and long term purchase decisions by using the results of the trend research and by analyzing trend curves of pre-specified new products and developments.

For analyzing of trends methods such as e.g. statistical analysis of tolerances, Delphi method (expert poll), prognosis methods using different trend models and results of the economic behavior research are used.

One important issue in the specifying of new trends is that a possible trend has to be determined and described. For the description of a trend usually an expression such as a term, a slogan, a phrase, a sound, a video, a code and the like has to be defined. In other words, an abstraction of the trend has to be predetermined by e.g. a linguistic or illustrative representation of the trend. Therefore, initially before starting an analysis whether an expression represents a possible trend the trend has to be identified as a possible one.

It is a general need that trends are recognized as soon as possible, i.e. in a very early phase. As general trends having a significant relevance for a market become shorter and shorter in time a trend tends to be identified increasingly later with regard to its respective phase with regard to its trend curve. In an economic background this might result in a missing of a market opportunity.

Additionally, even if a possible trend is identified the trend cannot be fully analyzed as not all implications of the trend are known. As a result, most of the trends are identified too late because the time period between development of the trend and the transition to a market phase has been too short or as the trend research could not specify the trend object using conventional means.

### SUMMARY OF THE INVENTION

It is an object of the present invention to provide a method and a system which allow identifying future trends in an improved manner, in particular, without providing predefined expressions representing the possible future trend in advance.

It is a further object of the present invention to identify trends having a predetermined behavior with regard to a known trend curve, and its spreading in its technical, social, political, or economical field.

The present invention provides a method for determining a significant change of an usage of expressions provided in a network system, including the steps of:
determining a reference data set including at least an expression frequency of expressions provided in the network system at a predetermined first time;
determining a result data set including at least an indication of an expression frequency change based on the reference data set, wherein the expression frequency change indicates the change of the expression frequency of expressions indicated by the reference data set at a predetermined second time;
extracting, from the result data set, one or more expressions according to one or more predetermined filters to determine the change of the usage of expression in the network system.

The present invention also provides a system for determining a change of an usage of expressions provided in a network system, comprising:
a reference unit for determining a reference data set including at least an expression frequency of expressions provided in the network system at a predetermined first time;
a difference determining unit for determining a result data set including at least an indication of an expression frequency change, wherein the expression frequency change indicates the change of the expression frequency of expressions indicated by the reference data set at a predetermined second time;
an extraction unit for extracting, from the determined data set, one or more expressions according to one or more predetermined filters to determine the change of the usage of expression in the network system.

According to one aspect a method for determining a significant change of a usage of expressions provided in a network system is provided. Therein, first a reference data set is determined including at least an expression frequency of expressions provided in the network system at a predetermined first time. Thereafter a result data set is determined including at least an indication of an expression frequency change based on the reference data set, wherein the expression frequency change indicates the change of the expression frequency of expressions indicated by the reference data set at a predetermined second time. Using the result data set it is extracted, from the result data set, one or more expressions according to one or more predetermined filters to determine the change of the usage of expression in the network system.

The present invention seeks e.g. to discover new trends at an early phase by examining a change of the usage of expressions and by recognizing a first usage of new expressions in a network system which is open to a large amount of users such as the Internet. The frequency of expressions in the network system is analyzed by comparing it with an initial state of frequencies such that an expression frequency change can be obtained. By using one or more filters the result data set indicating the expression frequency change can be condensed such that only expressions which are able to be a candidate to represent a potential trend are obtained. Thereby, it is possible to define trends in early phase which are represented by expressions in the network system.

Furthermore, the determining the result data set further comprises the steps of determining an actual data set indicating an expression frequency at the predetermined second time, and defining the result data set by the difference between the determined expression frequency and the reference expression frequency.

According to a further embodiment of the present invention the step of extracting is performed using a statistical filter wherein expressions of the result data set are eliminated from the result data set to obtain a statistically filtered result data set if their respective expression frequency change is below and/or above a predetermined threshold.

Moreover, the reference data set can further include a context information for the expressions indicating the usage context of the respective expression, wherein the step of extracting is performed using a context filter wherein filtering is performed based on the usage context.

In particular, the usage context is grammatical information indicating at least one of a use as a noun, a use as a verb, a use as an adjective.

According to one embodiment the step of extracting is performed using a database of expressions wherein expressions of the result data set are eliminated from the result data set if contained in the database.

Additionally, a step of mistyping detection can be performed for detecting a mistyped expression in the result data set based on the expressions of the database wherein the mistyped expression is eliminated from the result data set if the corresponding correctly typed expression is contained in the database. Alternatively, a step of mistyping detection can be performed for detecting a mistyped expression in the reference data set.

The reference data set and the actual data set may each include context information for the expressions indicating the usage context of the respective expression, wherein on both the reference matrix and the actual matrix a context filter is applied wherein filtering is performed based on the usage context.

Moreover, the determining of the reference data set may further comprise the including, into the reference data set, a site information related to the local occurrence of the expressions in the network system, wherein the step of extracting is performed using a geographic filter.

According to an embodiment a geographic filter is used to eliminate expressions from the result data set wherein a change of the occurrence of the expressions with respect to their site is below a threshold.

Furthermore, the determining of the reference data set may further comprises the step of including, into the reference data set, a media context information related to a media context in which the expression is embedded, wherein the step of extracting is performed using a media context related filter.

A media context related filter may be used to eliminate expressions from the result data set wherein a change of the media context information of the expressions is below a threshold.

According to a further embodiment, one or more further result data sets with respect to one or more third predetermined times are determined, wherein the step of extracting is performed by matching a predetermined function on the expression frequencies of the expressions in the data set such that expressions are eliminated from the further result data set if the variation of the further result data sets between the second and the one or more third times regarding the expression frequency is outside a range defined by the function.

After determining one or more further result data sets the reference data set may be updated taking into account at least one of the one or more further result data sets.

According to a further aspect a system is provided for determining a change of an usage of expressions provided in a network system, comprising a reference unit for determining a reference data set including at least an expression frequency of expressions provided in the network system at a predetermined first time; a difference determining unit for determining a result data set including at least an indication of an expression frequency change, wherein the expression frequency change indicates the change of the expression frequency of expressions indicated by the reference data set at a predetermined second time; and an extraction unit for extracting, from the determined result data set, one or more expressions according to one or more predetermined filters to determine the change of the usage of expression in the network system.

Preferred embodiments of the present invention are described in detail in conjunction with the accompanying drawings in which:

### BRIEF DESCRIPTION OF THE DRAWINGS

FIG. 1 shows a schematic diagram indicating a network system in which the method for determining a potential trend can be performed.

FIG. 2 shows a flow chart indicating the method steps of the method for determining potential trends.

FIG. 3 shows an example of the information about expressions which is stored in the 0-matrix.

FIG. 4 shows an example of the information about expressions which is stored in the actual matrix.

FIG. 5 shows an example of the information about the difference between the actual matrix and the 0-matrix which is stored in the result matrix.

### DETAILED DESCRIPTION

It is presumed that trends indicating social, political, and economical developments result in an increasing interaction/action of entities, mostly in form of linguistic or illustrative communication or publishing. Therefore, it might be possible that the interactions between the entities (persons, companies, organizations, and the like) and publications of entities reflect potential general trends already at an early state. This holds for any language area irrespective if roman or other characters are used to express linguistic expressions. Therefore, possible trends may be reflected by any linguistic expressions in any language which can be provided in form of “data segments”.

As the Internet, the worldwide, global information network, is increasingly used as a platform to perform linguistic communications of entities it can be regarded as reflecting the communication behaviour in general.

As trends are communicated usually using linguistic expressions, such as terms, slogans, phrases, codes, pictures, sounds, videos and so on, an analysis of the network communication and/or the information stored in network units might obviously be useful to determine when the overall usage of an expression changes in an aspect or when new expressions are coming up thereby reflecting the occurrence of new topics of interaction or changed importance of an expression possibly reflecting a new trend. As the linguistic expressions are normally stored and transmitted using a defined data structure (e.g. ASCII) the above holds for any languages and all scripts, e.g. Cyrillic script and Chinese script.

In the following description the term “expression” is used for any word, combination of characters and numbers, combination of a plurality of words and/or numbers which can occur in a document. It is understood that the term “expression” may also cover each other kind of “data segments” such as illustrations and other kinds of data words, as well. A document as understood herein is any logical data unit including a plurality of expressions such as website documents (HTML documents), text documents, database entries, data files and the like. Usually, documents are represented as files in a file system of the respected network unit to be examined or as data sets, objects etc. of databases in the network units.

FIG. 1 shows a schematic diagram indicating a network system 1 in which the method for determining a potential trend can be performed. The network system 1 can be e.g. the Internet, or any closed or locally defined network. The network system 1 comprises a plurality of network units 2, which are interconnected either directly or by means of routers, relay servers and the like such that the network units 2 can interact and a data communication using linguistic expressions in form of textual expressions, sounds, illustrations, pictures, videos etc. can be carried out between users of the different network units 2. The network units 2 can be user terminals, website servers or any other kind of information providing units, such as database servers and the like.

A method for determining a potential trend is performed by a trend determining unit 3 connected with the network units 2 of the network system 1 and operable to retrieve data from one, a plurality or each of the network units 2 for analyzing as it is explained later.

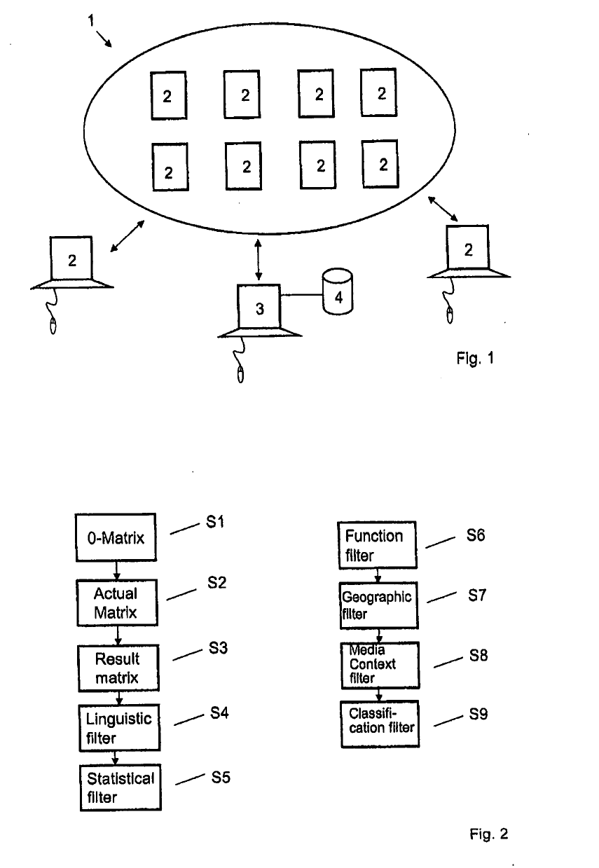

One embodiment of a method for determining a potential trend is depicted in the flow chart of FIG. 2.

In a first step S1, an initial state of the network with regard to (linguistic) expressions used therein is detected. The initial state is defined in a 0-matrix which is stored in a database 4 associated to the trend determining unit 3. The expressions occurring in the network system 1 are detected and counted. The 0-matrix indicates the various expressions existing within the network system 1 and their frequency of occurrence in the network at a predetermined initial (first) point of time or a predetermined initial (first) time period. The frequency of occurrence can reflect the frequency of an expression on a site basis, document basis (websites, data files) and on basis of other logical groups of data.

The 0-matrix is formed by searching websites and analysing at least their textual contents. The 0-matrix is formed with expressions and words, which occur in the contents of the websites and which are extracted therefrom as strings of characters and/or numbers separated from each other by blanks, punctuation marks and the like.

The so formed 0-matrix reflects an initial state. Consequently, expressions which are not contained in the 0-matrix have not occurred in the network at the predetermined initial point of time or initial time period. Found expressions may be stored in the 0-matrix in conjunction with an expression frequency value. The expression frequency value indicates that the expression have existed in the network system 1 at the predetermined initial point of time or initial time period. The expression frequency value then indicates for each expression the frequency the respective expression has occurred in the network system 1. As an alternative the expression frequency values can be stored in a database separated from the 0-matrix.

As one possibility of an indication for the occurrence of an expression in the network system 1, the number of times can be regarded by which one expression occurs in all of the documents stored in the network units 2 of the network system 1. The expression frequency indicates how many times one expression is stored in all of the network units 2 of the network system. It is possible to estimate the number of times all or at least a part of the occurring expressions exist in the network system 1. To create the 0-matrix thereby the documents (data files, websites, databases and the like) stored within the network has to be retrieved and analyzed by simply counting for each of the existing expressions the number of occurrences.

As an alternative it is also possible that the expression frequency is indicated in the 0-matrix as a classification value indicating the frequency of occurrence of the respective expression in all documents of the network. The overall frequency of the occurrence of a specific expression can be a sum of expression frequency values of the specific expression in each of the documents, wherein the expression frequency value of a specific expression for a specific document may equal 0 if the specific expression does not occur in the respective document, it may equal 1 if the specific expression only occurs for a low number such as two times in the specific document, it may equal 2, if the specific expression occurs for a larger number of times than two in the specific document. The overall number of classification values is not restricted to 3 (0, 1, 2). The classified expression frequency values may be simply added or combined according to another suitable function for all existing documents in the network system 1 such as to obtain an overall expression frequency value which assigned to the respective expression in the 0-matrix.

As another option it is also possible that the expression frequency can instead reflect the number of transmissions of an expression between entities of the network, i.e. between network units 2 which directly reflects the interactions of the entities using the network system.

As, however, the detection of the number of transmissions of the expressions is more difficult to detect than the number of occurrences of expressions in the documents stored in the whole network system 1 the method for determining potential trends is further described using the number of occurrences of expressions in documents stored in the network units 2 of the network system 1 as expression frequency values. Of course, the aspects of the present invention as described herein can also be applied using to the number of transmissions as the expression frequency. Furthermore, it is possible to consider both the number of occurrences of expressions stored in the documents of the network system and the number of transmissions of the expressions between network units 2 during the initial time period as two different expression frequency values.

The 0-matrix can include single words and combinations of several words. To condense the number of different expressions hold in the 0-matrix the 0-matrix may be preprocessed to obtain a modified condensed 0-matrix (also called 1-matrix). To reduce of the size of the 0-matrix, the expressions may be filtered such that a single word is not allowed to be larger than a predetermined first length (number of characters) (e.g. 15) and/or a chain of words is not allowed to be longer than a predetermined second length (number of characters) (e.g. 25). Expressions filtered out may be eliminated to obtain the modified 0-matrix (1-matrix). It may also be provided that expressions are filtered out having a length smaller than a predetermined third length to eliminate expressions which most likely do not express a potential trend due to their small length.

Furthermore, it may be provided that the 0-matrix is filtered such that only expressions having a expression frequency value in a specified range are included in the modifier 0-matrix. The specified range may be defined by a minimum expression frequency value and a maximum expression frequency value.

While the original 0-matrix is updated on a regular basis as pointed out below, the modified 0-matrix considers the first and second predetermined lengths. The modified 0-matrix is condensed with respect to the original 0-matrix to reduce the load of further processing. Besides the length filtering mentioned above, exponential and/or dictionary filters can be further applied on the 0-matrix to further condense the size of the 0-matrix. Either the original 0-matrix or the modified 0-matrix can be further applied to the following processing.

Once the 0-matrix has been established it gives an indication of an average usage of specific expressions in the network system 1 in the initial time period. In the following step S2, it is detected expressions which fall out of the range of the average usage of expressions, or new expressions which suddenly emerged in the network system 1. For detecting, the same procedure as used for establishing the (original or modified) 0-matrix is now applied for a second point of time or a second time period, respectively, to obtain an actual matrix.

The second point of time or a second time period is after the initial first point of time or initial first time period, respectively. In case of time periods the time periods can overlap or not. In case of time periods the time periods should be equal in length or their length should be in a predetermined relation. In case of an overlapping of the time periods the end time of the second time period should be after the end time of the first time period.

As the actual matrix is regarded with respect to the 0-matrix the actual matrix should be preprocessed in the same manner as the 0-matrix has been preprocessed to also condense the overall data size of the actual matrix.

In a step S3 a variation between the 0-matrix and the actual matrix is calculated to obtain a result matrix. The change between the actual matrix and the 0-matrix is obtained by simply calculating the difference of the expression frequency values of each expression in the 0-matrix and the actual matrix. The difference of the expression frequency values can be stored in the result matrix or in a frequency difference database separated therefrom.

In case of time periods of different lengths a weighting factor depending on the ratio of their lengths should be applied on the expression frequency values for each expression of one or both of the matrices.

As a result, it is obtained a result data set, i.e. a result matrix which indicates the expression frequency change for each expression indicated in the (original or modified) 0-matrix. The expression frequencies in the 0-matrix and the result matrix are preferably provided in a normalized manner, e.g. with regard to the total expression count of the network system.

After obtaining the result matrix one or more filters are applied to extract the relevant expressions from all expression indicated in the result matrix.

In a next step S4 a linguistic filter is applied on the result matrix. The linguistic filter filters out expressions which belong to the common vocabulary of the different languages (provided by word dictionaries) and which are not used in a specific context, i.e. expressions which are not used as a noun or in substantival manner. The linguistic filter can be provided optionally depending on the kind of trend which is to be detected. In case it is intended to detect product trends the linguistic filter should be applied, in cases of the detection of social, political and/or economic developments it might be useful to deactivate the linguistic filter. Moreover, it is useful that the linguistic filter also regards the spelling of an expression in upper case or lower case letters.

As a linguistic filter an existing filter system could apply methods for extracting proper names be used for recognition of product names and proper names, such as Proper Name Facilitie (PNF) by Sparser, BSEE von FACILE/CONCERTO (UMIST, University of Manchester, UK), LaSIE (NLP group, University of Sheffield, UK), LT TTT (Language Technology Group, University of Edinburgh, UK), NetOwl (IsoQuest Inc., Fairfax, Va./USA), Oki Informations-Extraktions-System (Oki Electric Industry Co., Ltd., Osaka, Japan), LOLITA (Laboratory for Natural Language Engineering, Department of Computer Science, University of Durham, UK), PIE-System enhanced proper names recognition by means of collocation-statistics (Department of Computer Science, University of Manitoba, Winnipeg, Canada), IdentiFinder (BBN Technologies, Cambridge, Mass./USA), MENE (Computer Science Department, New York University, New York, N.Y./USA), Japanese NE-System used for MET-2 (Computer Science Department, New York University, New York, N.Y./USA), Jeannette Roth, “Der Stand der Kunst in der Eigennamen-Erkennung, Mit einem Fokus auf Produktenamen-Erkennung”, Lizentiatsarbeit der Philosophischen Fakultat der Universitait Zuirich, 2002 etc.

Furthermore, expressions are filtered out which are clearly spelled incorrectly and/or are related to conventional describing expressions as can be found in the above word dictionary or a wordbook and/or which are clearly related to product names such as trademarks, proper names and the like. Product names, for instance, can be found out as product names are mostly written in capital letters at least in western languages and as the product names are commonly used with its articles. Further, different cases of the same expression are summarized e.g. into the basic noun form (nominative form) in case of a noun. Such a linguistic filter can be applied to reduce the overall number of expressions supplied to filters applied thereafter. The linguistic filter can alternatively be applied to the 0-matrix (after step S1) and the actual matrix (after step S2) before the calculation is started to obtain the result matrix. In case that only the nouns or the expressions used substantially are considered the number of expressions in the matrices can be reduced significantly. Furthermore, in the linguistic filter only expressions of a predetermined language should be considered.

In a further step S5, after applying the linguistic filter a statistical filter can be applied which eliminates, from the result matrix, the expressions the expression frequency change of which is below a predetermined threshold. Thereby, statistically insignificant frequency changes of expressions can be disregarded such that only expressions the occurrences of which have a significant frequency change are further considered.

Linguistic filter and statistical filter are called word filters as the expressions are filtered with respect to formal criterias.

Thereafter, one or more trend filters may be applied. The method of the present invention is further described using all of the trend filters whereas it is also possible to use one of the trend filters or in different combinations.

A first example for a trend filter, as shown in step S6, is a function filter which examines the characteristic of a frequency change of a respective expression over a plurality (at least two) of second time periods indicated by a plurality of actual matrices. At least one of the change of the frequency of a respective expression and the change of the frequency change of an respective expression can be analyzed and compared to a given function to determine whether the change of the frequency of a respective expression can be described by the given function or not. In case it is possible to describe the change of the frequency of the respective expression with the given function the occurrence of the expression may be associated to specific phase in a trend curve which may be understood as an indication for the existence of a trend.

For instance, an exponential function is a rough indication of an existence of a trend in an early phase. Instead of the exponential function which is merely useful to describe the initial phases of a trend a trend function can be used which describes other phases of a trend in the trend lifetime. The function filter functions such that the frequencies of the respective expressions to be examined are used to match to a trend curve (e.g. the exponential curve) or not. In case no trend curve or exponential curve could be matched with the characteristic of the frequencies of the respective expressions at various time periods (time points) the respective expressions might be eliminated from the data set, i.e. the set of expressions included in the result matrix, as expressions which do not indicate a trend.

As a second example for a trend filter a geographic filter can be applied in a step S7. For applying the geographic filter the occurrences of each expression has to be associated with a site information in a geographic localization process. The geographic localization process associates the IP address of the domain on which a respective expression has occurred with a site information. The site information indicates for each occurrence of the expression the place, the region, the country etc. where the network unit 2 is located on which the document including the respective expression is stored. To use such a trend filter the 0-matrix as well as the actual matrix (or respective associated databases) have to be provided with the indication of the expression, the frequency of an occurrence of the respective expression in the network system and associated therewith a site information which indicates the place, region, country and the like where the respective occurrence of the expression is stored.

In the result matrix it is then indicated additionally to the change of the frequency of a respective expression, information about a change of the geographic (local) focus of a respective expression. In case it is detected that no significant number of occurrences of one respective expression has left a locally limited area the respective expression can be eliminated from the result matrix. Otherwise, in case that a significant number of occurrences of the one expression has left the geographically limited area the expression is a possible candidate for indicating a potential trend.

The geographic filter tries to reflect the observation that in an early phase of the development of a trend a trend spreads from a locally limited seed area to other areas which might be regarded as one main aspect when a trend is going to be established.

Additionally or instead of the geographic filter a virtual localization filter can be applied which checks whether a respective expression has a predetermined frequency in a specific virtual domain or specific virtual domains, such as internet web addresses having a suffix “.de” or “.cn”.

Similarly, as another example for trend filter a media context filter can be applied in a step S8 which uses media context information which is stored in both the 0-matrix and the obtained actual matrix and actual matrices, respectively. Media context information is a kind of information similar to the site information which is stored with each occurrence of a respective expression that indicates the kind of media context and the “virtual” place at which the expression occurred. A media context information might indicate if the expression occurred in a forum, guest book, blog, news article, database, and the like. Moreover, the media context information can indicate a topic such as fashion, sports, politics etc. Furthermore, the media context information can indicate if the respective expression occurred in a cluster of network units 2 locally spread but belonging to the same information/service provider or information providers belonging to a same economic sector. Similarly to the handling of the site information the media context information is used to eliminate expressions from the result matrix which have not substantially changed in view of its the media contexts which can be determined by a comparison of the media contexts of one expression indicated in the 0-matrix with the media contexts of the same expression indicated in the actual matrix.

Furthermore, a language filter can be applied which can detect for an expression in a specific language whether it occurred in a context (e.g. a document) in a different language which may be an indication for a “trend word”, e.g. an English expression in an Italian or Spanish text.

The above described trend filters can be combined in any way such as to apply one, two or three of the trend filters.

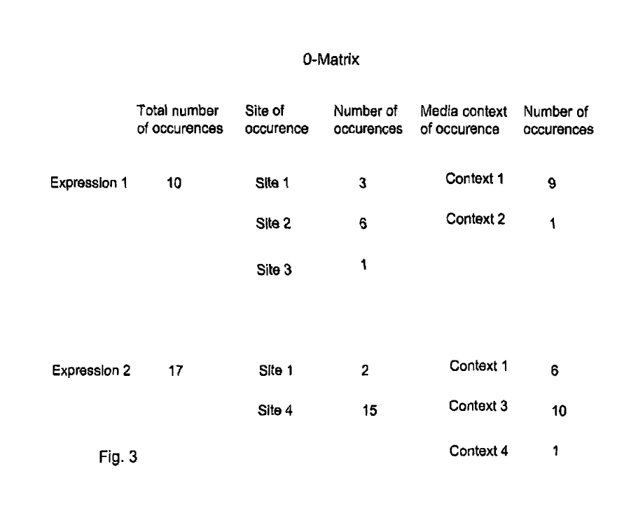

For further understanding the FIGS. 3 to 5 show tables representing the information stored with expressions “Expression 1” and “Expression 2” in the 0-matrix and the actual matrix such that the result matrix can be calculated by subtracting the both matrices. The result matrix can then be used to apply above mentioned filters.

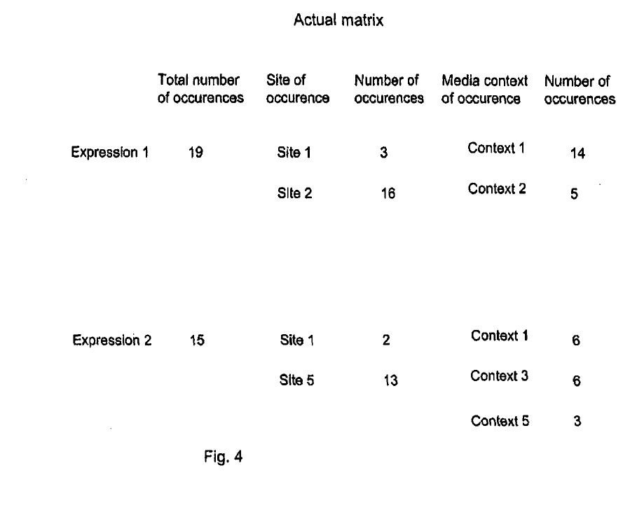

For the 0-matrix, as shown in FIG. 3, and the actual matrix, as shown in FIG. 4, to each expression “Expression 1” and “Expression 2” the total number of occurrences is stored. Furthermore, the number of occurrences at the sites (geographic positions) at which the expressions “Expression 1” and “Expression 2” occurred and the number of occurrences at each of the geographic positions are indicated. In a similar manner the media context occurrences together with the number of occurrences in the respective media context are indicated.

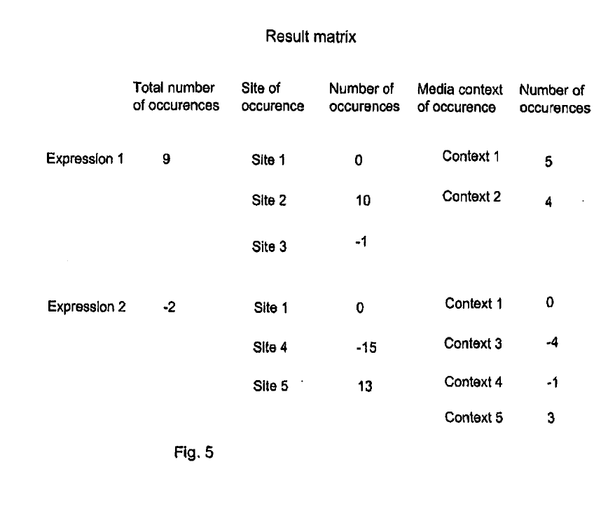

As shown in FIG. 5, the result matrix is calculated by simply subtracting the number of occurrences for each of the sites of occurrence and for each of the media contexts of occurrence, respectively.

Instead of providing all necessary information in the 0-matrix, the actual matrix and the result matrix, it is also possible to construct the matrices as mere word lists wherein each word is linked to a respective database in which the expression frequency, site information, context information and further necessary information mentioned above is stored.

After having applied the trend filters a classification filter is used in step S9 which is adapted to examine the semantic context in which the respective expression in the result matrix is used. As a context different economic sectors and topics can be used which can be associated to the respective document the expression occurred or the environment of the expression in the documents in which the expression occurred is examined to find out if the contexts are similar or not. If it turns out that the contexts of the expression in different documents differs beyond a predetermined threshold the expression is eliminated. Otherwise the expression is associated with the respective context, i.e. the sector, e.g. sports, fashion, music and the like for often used words in the context of the expression are associated with the expression.

To indicate relevant trends more than one actual matrix has to be created. By combining the 0-matrix with the actual matrix of a directly succeeding time period, such as by simply adding the number of occurrences, a new 0-matrix can be created which is refined with respect to the former 0-matrix as the time period in which the occurrences of expressions are examined is increased.

Thereby, the existence of outlier frequencies of an expression in a statistical meaning can be reduced. As mentioned above, the time periods in which the number of occurrences then becomes different such that a normalizing of the matrices with regard to the total number or occurrences should be preferably performed.

In general, each of the filters may be optionally used as a single filter or in combination. The set of used filter processes can be fully or partly performed before the determining of the result matrix, i.e. on both the 0-matrix (to obtain the modified 0-matrix) as well as on the actual matrix to shrink the size of the result matrix. Alternatively, the set of used filter processes can be fully or partly performed after the determining of the result matrix, i.e. on the result matrix. Conveniently, one or a combination of simple “formal” filter processes can be applied before the determining of the result matrix and one or a combination of further “trend” filter processes can be carried out after the determining of the result matrix.

In general, the order of applying the different filter processes may be random. Preferably, the order of applying the different filter processes may depend on the specific kind of trend to be detected. In particular, it is preferred to apply filters in the order statistical filter, linguistic filter, geographic filter, and context filter. However, other orders are possible as well.

The above mentioned method has been described with regard to a method for determining a potential trend but can also be applied on any other technical field in which the change of the frequency of an occurrence of expressions has to be examined. For example the spreading of viruses in a network can be examined if an identifying portion of a code of the virus can be automatically detected. Documents are then represented by executable files or code.

What is claimed is:

1. A method for determining a significant change of an usage of expressions provided in a network system comprising the steps of:
determining a reference data set including at least an expression frequency of expressions provided in the network system at a predetermined first time;
determining a result data set including at least an indication of an expression frequency change based on the reference data set, wherein the expression frequency change indicates the change of the expression frequency of expressions indicated by the reference data set at a predetermined second time;
extracting, from the result data set, one or more expressions according to one or more predetermined filters to determine a change of the usage of the expression in the network system.

2. The method according to claim 1 wherein the determining the data set further comprises the steps of:
determining an actual data set indicating an expression frequency at the predetermined second time, and
defining the result data set by the difference between the determined expression frequency and the reference expression frequency.

3. The method according to claim 1 wherein the step of extracting is performed using a statistical filter wherein expressions of the data set are eliminated from the data set if their respective expression frequency change is below a predetermined threshold.

4. The method according to claim 1 wherein the reference data set further includes a context information for the expressions indicating the usage context of the respective expression, wherein the step of extracting is performed using a context filter wherein filtering is performed based on the usage context.

5. The method according to claim 4 wherein the usage context is a grammatical information indicating at least one of a use as a noun, a use as a verb, a use as an adjective.

6. The method according to claim 1 wherein the step of extracting is performed using a database of expressions wherein expressions of the result data set are eliminated from the result data set if contained in the database.

7. The method according to claim 6 further comprising the step of mistyping detection for detecting a mistyped expression in the result data set based on the expressions of the database wherein the mistyped expression is eliminated from the result data set if the corresponding correctly typed expression is contained in the database.

8. The method according to claim 2 wherein the reference data set and the actual data set each include a context information for the expressions indicating the usage context of the respective expression, wherein on both the reference matrix and the actual matrix a context filter is applied wherein filtering is performed based on the usage context.

9. The method according to claim 1 wherein the determining of the reference data set further comprises including, into the reference data set, a site information related to the local occurrence of the expressions in the network system, wherein the step of extracting is performed using a geographic filter.

10. The method according to claim 9 wherein a geographic filter is used to eliminate expressions from the result data set wherein a change of the occurrence of the expressions with respect to their site is below a threshold.

11. The method according to claim 9 wherein the site information comprises at least one of a geographic information and a network location information.

12. The method according to claim 1 wherein the determining of the reference data set further comprises the including, into the reference data set, a media context information related to a media context in which the expression is embedded, wherein the step of extracting is performed using a media context related filter.

13. The method according to claim 12 wherein the media context related filter is used to eliminate expressions from the result data set wherein a change of the media context information of the expressions is below a threshold.

14. The method according to claim 12 wherein the media context information comprises a least one of a virtual room, media type, and a sectoral classification.

15. The method according to claim 1 further comprising determining one or more further data sets with respect to one or more third predetermined times, wherein the step of extracting is performed by matching a predetermined function on the expression frequencies of the expressions in the result data set such that expressions are eliminated from the result data set if the variation of the data sets between the second and the one or more third times regarding the expression frequency is outside a range defined by the function.

16. The method according to claim 15, wherein after determining one or more further data sets the reference data set is updated taking into account at least one of the one or more further data sets.

17. A system for determining a change of an usage of expressions provided in a network system, comprising:
a reference unit for determining a reference data set including at least an expression frequency of expressions provided in the network system at a predetermined first time;
a difference determining unit for determining a result data set including at least an indication of an expression frequency change, wherein the expression frequency change indicates the change of the expression frequency of expressions indicated by the reference data set at a predetermined second time;
an extraction unit for extracting, from the determined data set, one or more expressions according to one or more predetermined filters to determine the change of the usage of expression in the network system.

18. A computer program product tangibly stored on an information carrier and including program instructions that when executed on a computer perform the method according to claim 1.
